(19) United States
(12) Patent Application Publication
(10) Pub. No.: US 2007/0018597 A1
(43) Pub. Date: Jan. 25, 2007

(54) System for damping of phase shifts and for attenuation of harmonics between at least one energy source and at least one brushless electric motor

(75) Inventor: Carlhermann Schlehaus, Weikersheim (DE)

Correspondence Address: BACHMAN & LAPOINTE, P.C., 900 CHAPEL STREET, SUITE 1201, NEW HAVEN, CT, 06510, US

(73) Assignee: Wittenstein AG

(21) Appl. No.: 11/479,790

(22) Filed: Jun. 30, 2006

(30) Foreign Application Priority Data
Jul. 22, 2005 (DE) 102005034955.2-32

(51) Int. Cl. H02K 23/00

(52) U.S. Cl. 318/437

(57) ABSTRACT

In a system for damping of phase shifts and for attenuation of harmonics between at least one energy source and at least one brushless electric motor in aircraft, the object is to connect an active circuit for attenuation of harmonics of the current and of the high-frequency waves of the three-phase current between the at least one energy source (1) and the at least one electrically commutated brushless motor (10).

### BACKGROUND OF THE INVENTION

The present invention relates to a system for damping of phase shifts and for attenuation of harmonics between at least one energy source and at least one brushless electric motor in aircraft.

Systems such as these are known and available on the market in a very wide range of forms.

In particular, it is known for a three-phase current to be converted to a direct current by means of appropriate rectifiers, bridge circuits.

Reversible converters, for example a cross circuit, circuits which are free of circulating currents, etc. are known for this purpose.

In fact, conventional asynchronous machines are normally replaced by brushless electronically commutated motors in many areas of drive technology.

These motors offer better output power levels in more compact physical spaces and with better control characteristics. Their disadvantage is that brushless electronically commutated motors such as these cannot be operated directly from three-phase power supply systems, since it is not possible to connect these synchronous motors to them.

The present invention is thus based on the object of providing a system of the type mentioned in the introduction which overcomes the stated disadvantages and by means of which even brushless electronically commutated motors can be operated in a simple and cost-effective manner without a high harmonic content.

Particularly in aviation, the aim is in this way to make it possible to produce reliable drives which require less physical space and whose weight is less.

### SUMMARY OF THE INVENTION

The object is achieved by providing an active circuit for attenuation of harmonics of the current and of the high-frequency waves on the three-phase current is connected between the at least one energy source and the at least one electrically commutated brushless motor.

In the case of the present invention, the use of electronically commutated brushless motors as a replacement for asynchronous machines is particularly important. In this case, in aviation, aircraft are intended to be equipped with correspondingly brushless motors without any need to replace the previous generators which operate in the three-phase mode.

The intention of this is, in particular, to achieve a weight saving and a saving in installation space.

Furthermore, brushless motors such as these are intended to have the capability to be connected directly to the aircraft power supply system, with correspondingly occurring harmonics in the system being regulated out or reduced.

In this case, in order to produce the rotating field in the stator of the motor, the motor phases are connected by means of actively controlled circuit breakers and switches in an intermediate circuit and the DC voltage connection of a bridge circuit. The appropriate choice of the control sequence of these switches and circuit breakers produces a magnetic field in the stator of the motor, thus resulting in an output drive torque being formed in conjunction with the magnets on the rotor and the position of the rotor with respect to the stator magnetic field. When the motor is rotated by this torque, that is to say the position of the rotor with respect to the stator changes, the control sequence is adapted. The stator magnetic field is slaved to the movement of the rotor, and the output drive torque then remains constant.

The intermediate-circuit or bridge-circuit DC voltage required for this purpose is available only when the electronics or the controller are or is connected directly to a DC voltage energy source. If the electronics or the controller are or is supplied with energy by means of a single-phase or polyphase power supply system, as is the case with the present invention, the AC voltage must first of all be rectified.

Conventional bridge-rectifier circuits or bridge circuits, B4 or B6 are used for this purpose, which feed a buffer element or capacitor in the DC voltage intermediate circuit. The commutation output stage is connected to this internally produced DC voltage intermediate circuit. The non-linear characteristic of the diodes, in particular of the input rectifier diodes, produces the needle-shaped current pulses, which are characteristic of this circuit, in the phases u, v, w of the energy source, corresponding to the three-phase power supply system.

By way of example, the current curve can be broken down by means of Fourier analysis into sinusoidal current curves of a different type in terms of their frequency and the magnitude of the voltage. The current curve is broken down into a fundamental at the same frequency as the power supply system voltage, and harmonics at integer multiples of the fundamental frequency. Multiplication of the fundamental, that is to say of the voltage, by the current results in a real power which is consumed by the energy sink, that is to say by the load or by the brushless motor. The sum of the multiplications of the current harmonics, that is to say the voltage multiplied by the current, in which case the harmonics must be used for the current, results in the wattless component oscillating between the energy source, that is to say the generator, and the load. With regard to the effect of the current harmonics, the energy source must be designed in accordance with the sum of the real power and wattless component, even though the load or the brushless motor converts only the real power into usable output power.

The energy source must therefore be overdesigned in direct comparison with the pure outlet power of the connected load.

If the supply lines, that is to say the phases, are not protected by thermal fuses, but are designed on the basis of semiconductor switches, erroneous switching-off operations can occur depending on the method used for current measurement.

The current harmonics are essentially filtered out at the transfer point between the energy source and the DC voltage power supply system during operation.

In consequence, it has been found to be advantageous in the case of the present invention to provide each diode within the bridge circuit with a controllable switch which can be driven via a controller. In order to regulate out or to considerably reduce the harmonics, the time profile is matched via the controller or via the control loop to the time profile of the voltages. This allows the harmonics to be regulated out.

This results in an active system or an active circuit. The main purpose of the system or of the circuit is to provide so-called power factor correction, that is to say the ratio of the real power to the volt-amperes consumed, in order to optimize the required energy source. The principle of operation of this so-called PFC (power factor correction) is that the current harmonics are at the same time adapted or matched by active shaping of the consumed line current to form a current which is in phase with the line voltage.

### BRIEF DESCRIPTION OF THE DRAWINGS

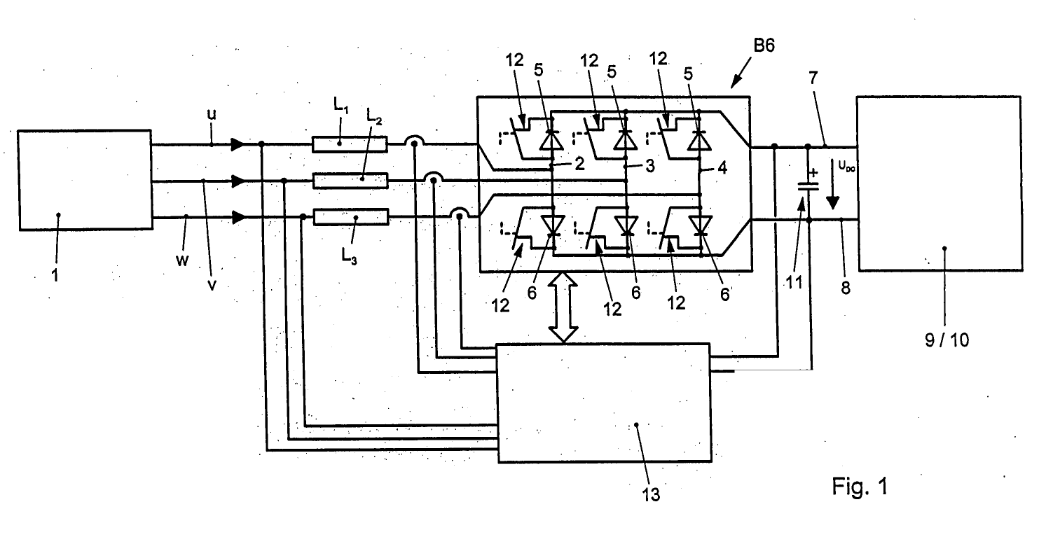

Further advantages, features and details of the invention will become evident from the following description of one preferred exemplary embodiment, illustrated in FIG. 1.

### DETAILED DESCRIPTION

FIG. 1 shows a schematically illustrated simplified PFC (power factor correction) circuit, in which an energy source 1 is, for example, in the form of a generator and produces a three-phase AC voltage in order to supply a DC intermediate circuit.

In each phase u, v, w, the line voltage is preferably 115 V and the phase voltage is preferably 200 V, at a frequency of 400 Hz.

Inductors L₁, L₂ and L₃ are in each case inserted adjacent to the energy source 1 in the respective phases u, v, w.

In this case, each phase u, v, w is passed to a partial converter, which is formed from a first, a second and a third branch 2, 3, 4.

Originated from each branch 2, 3, 4, two diodes 5, 6 are in each case arranged in the form of a so-called bridge circuit, B6 or B4 and lead via lines 7, 8 to a load 9, in the form of a brushless electrically commutated motor 10.

A capacitor 11 is inserted between the lines 7, 8 and between the bridge circuit B6 or B4.

One special feature of the present invention is that each diode 5 and each diode 6 in the respective branches 2, 3, 4 is bridged by a drivable switch 12.

Each diode 5, 6 in the branches 2, 3, 4 can be bridged via the drivable switch 12. This switch 12 is driven and controlled via a controller 13.

The controller 13 is connected on the one hand to the lines 7, 8 between the bridge circuit B6 or B4 and the load 9, in particular the brushless motor 10, and on the other hand the controller 13 is connected by means of the respective phases u, v, w of the energy source 1, before voltage measurement and in each case after current measurement, to the inductors L₁, L₂ and L₃, as is indicated in FIG. 1.

In this case, it has been found to be particularly important for the purposes of the present invention not only to connect the respective inductors L₁, L₂ and L₃ upstream of the bridge circuit B6, but for it to be possible to bridge the respective diodes 5 and/or 6 in the individual branches 2, 3, 4 via the individual switches 12.

In this case, the corresponding voltages on the phases u, v, w can be determined and measured in the controller 13 upstream of the inductors L₁, L₂, L₃.

The controller 13 can be switched on the basis of the measured voltages and phase shifts in such a way that the magnitude of the current on the one hand can be regulated, and on the other hand the time profile of the current can be matched to the time profile of the voltage, thus allowing the harmonics to be regulated out.

If, by way of example, the lower switch 12 in the branches 2, 3 and/or 4 is short-circuited at an appropriate phase angle of the voltage from the source, then an inductance is built up within the inductors L₁, L₂, L₃, in particular a strong magnetic field, with the lower switch 12 then subsequently being opened again at the diodes 6, so that the current which is stored in the inductors L₁, L₂, L₃ then migrates via the other diodes 5 into the capacitor 11, and the switch 12 is opened and/or closed, depending on the clocking. This allows regulation, in particular regulation of the magnitude of the current.

The switches 12 are driven by the controller 13 in such a manner that the time profile of the current in the system is matched to the time profile of the voltage. This results in disturbing harmonics in the power supply system through the load being regulated out or attenuated.

By way of example, the current can be operated in a sinusoidal form by appropriate driving, that is to say opening and closing by means of the controller 13, via the switches 12 for the diodes 5 and/or 6, in which case the sinusoidal currents can be matched to a map of the applied voltage in order to reduce the harmonics.

1. System for damping of phase shifts and for attenuation of harmonics between at least one energy source and at least one brushless electric motor in aircraft, comprising an active circuit for attenuation of harmonics of current and of high-frequency waves of three-phase current is connected between an at least one energy source (1) and an at least one electrically commutated brushless motor (10).

2. System according to claim 1, wherein the harmonics of the current can be reduced by means of an active PFC circuit.

3. System according to claim 1, including means for correcting a ratio of the real power (P) to the consumed power (S).

4. System according to claim 1, wherein the current harmonics is carried out by active shaping of the current drawn to form a current in phase with the voltage.

5. System according to claim 2, wherein a B4 or B6 bridge circuit is used for the active PFC circuit.

6. System according to claim 5, wherein a power supply system having a frequency of about 400 Hz is used for a three-phase PFC circuits.

7. System according to claim 2, wherein the PFC circuit as well as the electric brushless motor (10), are allocated in order to reduce the harmonics on the current.

8. System according to claim 1, including providing inductive current branches to reshape the phase current.

9. System according to claim 8, wherein the phases (u, v, w) of the at least one energy source (1) are connected via power inductors (L₁, L₂, L₃) to an actively controlled circuit B4 or B6.

10. System according to claim 9, wherein a switch (12) in the PFC circuit is driven to reshape the phase current in conjunction with the inductors (L₁, L₂, L₃).

11. System according to claim 1, wherein the electric motor (10) is a resistive load to the at least one energy source (1) by reshaping of the current, and a power factor can be controlled in this way.

12. System according to claim 1, wherein harmonics of the current are reduced by simultaneous shaping of the current to form a sine wave.

13. System according to claim 1, wherein an inductor (L₁, L₂, L₃) is inserted in each phase (u, v, w) between the energy source (1) and the bridge circuit (B6 or B4).

14. System according to claim 9, wherein branches (2, 3, 4) are connected to each phase (u, v, w) in conjunction with the inductors (L₁, L₂ L₃), with two diodes (5, 6) being arranged on each branch (2, 3, 4), wherein diode 5 is connected to a first line (7) and diode (6) is connected to a second line (8).

15. System according to claim 14, wherein a brushless electrically commutated motor (10), is connected to the first and second lines (7, 8), with at least one capacitor (11) inserted between the lines (7, 8).

16. System according to claim 15, wherein a controller (13) is connected to the respective phases (u, v, w) upstream and downstream of the inductors (L₁, L₂, L₃), and is connected to the lines (7, 8).

17. System according to claim 14, wherein each diode (5, 6) is driven and is bridged by a drivable switch (12).

18. System according to claim 17, wherein each switch (12) for the diodes (5, 6) is driven via a controller (13) via software.

19. System according to claim 18, wherein magnitude of the current (I) can be regulated via the controller (13) as a function of clocking of each switch (12) of the diodes (5 and/or 6).

20. System according to claim 19, wherein time profile of the current is regulated with respect to the time profile of the voltage in order to reduce harmonics by the controller (13), wherein each switch (12) for the diodes (5 and/or 6) is driven appropriately.
